(19) United States
(12) Patent Application Publication
(10) Pub. No.: US 2015/0030975 A1
(43) Pub. Date: Jan. 29, 2015

(54) TONER PRODUCTION METHOD, TONER, DEVELOPMENT DEVICE, AND IMAGE FORMATION APPARATUS

(71) Applicant: Oki Data Corporation, Tokyo (JP)

(72) Inventor: Hiroshi TAKANO, Tokyo (JP)

(21) Appl. No.: 14/339,518

(22) Filed: Jul. 24, 2014

(30) Foreign Application Priority Data
Jul. 26, 2013 (JP) 2013-155111

(51) Int. Cl. G03G 9/00

(52) U.S. Cl. CPC G03G 9/0804; G03G 2215/066
USPC 430/105; 430/137.1

(57) ABSTRACT

A toner is manufactured by a dissolution suspension method, wherein a colorant that is capable of being dissolved in a predetermined amount into ethyl acetate is used, and no pigment dispersant is used.

### CROSS REFERENCE TO RELATED APPLICATIONS

This application claims priority based on 35 USC 119 from prior Japanese Patent Application No. 2013-155111 filed on Jul. 26, 2013, entitled “TONER PRODUCTION METHOD, TONER, DEVELOPMENT DEVICE, AND IMAGE FORMATION APPARATUS”, the entire contents of which are incorporated herein by reference.

### BACKGROUND OF THE INVENTION

1. Field of the Invention

This disclosure relates to a toner production method, a toner, a development device, and an image formation apparatus.

2. Description of Related Art

In a conventional image formation apparatus (such as an electrophotographic printer, a copier, and a facsimile), a charge device electrically and uniformly charges the surface of a photosensitive drum, and an exposure device exposes to light the charged surface of the photosensitive drum to form an electrostatic latent image. Then, a development device applies a toner to the electrostatic latent image, and the resulting toner image is transferred to a medium to thus form an image.

Meanwhile, as a technique to eliminate uneven glossiness on an image (i.e., to make it even), there has been developed an image formation technique using a clear toner, that is, a toner obtained by removing a colorant component from a normal color toner. For example, the following technique has been developed. Specifically, a clear toner is supplied onto a medium on which an image has been formed with a color toner. The clear toner is fixed by heating to thereby form a clear toner particle layer. Thus, an image is formed having an even glossiness on the entire surface of the medium.

In addition, recently there has also been developed a technique for forming a special image by using a security toner capable of emitting light upon exposure to ultraviolet light, with the toner also having such visually unrecognizable properties of a clear toner (see, for example, Japanese Patent Application Publication No. 2011-123487).

### SUMMARY OF THE INVENTION

However, the conventional image formation apparatuses have a problem in that even if a clear toner or a security toner is used, a fogging phenomenon may occur. This is caused when a small amount of the toner is transferred to a blank portion of a medium where no image is formed, which produces a staining of the blank portion.

An object of an embodiment of the invention is to provide a toner capable of emitting light upon exposure to ultraviolet light and suppressing fogging.

An aspect of the invention is a toner production method of producing a toner by a dissolution suspension method, wherein a predetermined amount of a colorant that is capable of being dissolved in ethyl acetate is used, and wherein no pigment dispersant is used.

In other words, an aspect of the invention is a toner production method of producing a toner by a dissolution suspension method which is well known to any person skilled in the art to which it pertains and disclosed, for example, in U.S. patent application publication US2007/0054210, except that a predetermined amount of a colorant that is capable of being dissolved in ethyl acetate is used and no pigment dispersant is used. The toner production method(s) by the dissolution suspension method(s) disclosed in U.S. patent application publication US2007/0054210 is incorporated its entirety herein by reference.

According to this aspect of the invention, a toner is provided that is capable of emitting light upon exposure to ultraviolet light and suppressing fogging.

### BRIEF DESCRIPTION OF THE DRAWINGS

FIG. 1 is a schematic configuration diagram of an image formation apparatus according to a first embodiment of the invention.

FIG. 2 is a schematic configuration diagram of a development device and a fixer according to the first embodiment of the invention.

FIG. 3 is a drawing for explaining a method of evaluating Examples according to the first embodiment of the invention.

FIG. 4 is a table for illustrating compositions of dispersed phases of Examples according to the first embodiment of the invention.

FIG. 5 is a table for illustrating Ca element amounts and the evaluation results of Examples according to the first embodiment of the invention.

FIG. 6 is a table for illustrating how the solubilities of fluorescent materials of the Examples according to the first embodiment of the invention correlate with deposition and toner coloration.

FIG. 7 is a table for illustrating a composition of a dispersed phase of an Example according to a second embodiment of the invention.

FIG. 8 is a table for illustrating a Ca element amount and the evaluation result of the Example according to the second embodiment of the invention.

### DETAILED DESCRIPTION OF EMBODIMENTS

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

Hereinafter, embodiments of the invention are described in detail with reference to the drawings.

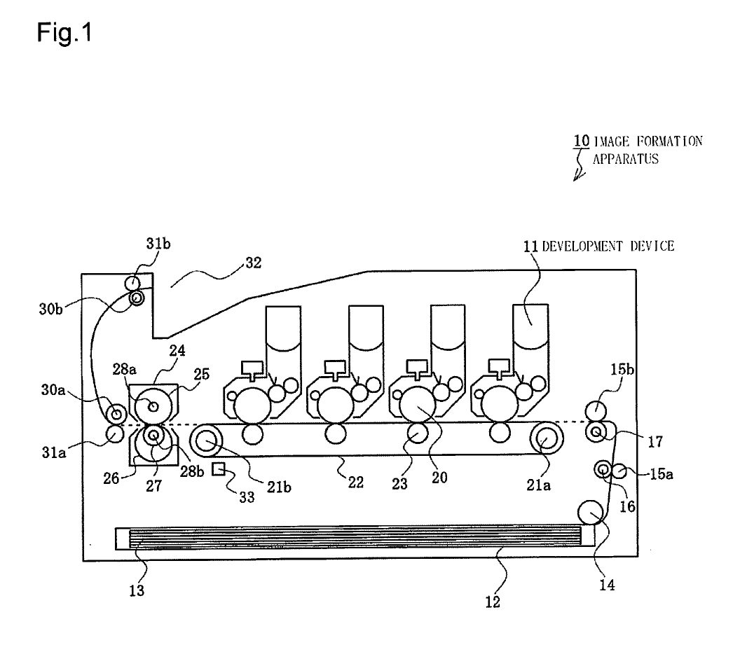

FIG. 1 is a schematic configuration diagram of an image formation apparatus according to a first embodiment of the invention.

In the figure, reference numeral 10 denotes an image formation apparatus, for example, an electrophotographic printer, a facsimile, a copier, or a multi function printer (MFP) having functions of a printer, a facsimile, and a copier, or the like. The image formation apparatus may be of any type. Note that this embodiment describes a case where image formation apparatus 10 is a so-called tandem electrophotographic color printer.

Here, in image formation apparatus 10, development devices 11 respectively corresponding to four colors of black (K), yellow (Y), magenta (M), and cyan “A” are sequentially aligned in a conveyance direction (leftward in the figure) along a conveyance path of medium 13. Note that development devices 11 all have the same configuration, but the colors of toners 40, to be described later, accommodated therein as a developer are different. Meanwhile, each development device 11 is installed as a detachable independent unit in image formation apparatus 10, and is configured to form an image, or in other words, to perform printing, on medium 13 conveyed along the conveyance path.

Reference numeral 12 denotes a paper cassette as a medium accommodation unit installed at a bottom portion of the main body of image formation apparatus 10. Paper cassette 12 is configured to accommodate media 13, such as recording paper stacked on each other. Additionally, hopping roller 14 is configured as a medium feed member to feed media 13 one by one from paper cassette 12. Conveyance roller 16 and pinch roller 15a are configured to convey medium 13 to resist roller 17 and pinch roller 15b configured to correct an off-course movement of medium 13. While being stopped, resist roller 17 and pinch roller 15b stop the conveyance temporarily. Resist roller 17 and pinch roller 15b are configured to detect a tip end in a travel direction of medium 13, temporarily stop medium 13, and then feed out medium 13 in synchronization with an image-formation timing of development devices 11. Each of hopping roller 14, conveyance roller 16, and resist roller 17 is configured to rotate by a power transmitted from an unillustrated drive source via a gear and so forth.

A transfer unit is disposed at a position facing photosensitive drums 20 as electrostatic latent image bearing members of development devices 11. The transfer unit includes drive rollers 21a and 21b, transfer belt 22, and transfer rollers 23. A voltage is applied to each transfer roller 23 in such a manner that there is a potential difference between a surface potential of photosensitive drum 20 and a surface potential of transfer roller 23 when a toner image is transferred to medium 13 from a toner adhering to photosensitive drum 20. Further, drive rollers 21a and 21b are configured to rotate by a power transmitted from an unillustrated drive source via a gear and so forth to thereby rotate transfer belt 22.

Transfer belt 22 is configured to convey medium 13 having been conveyed to transfer belt 22 by resist roller 17 and pinch roller 15b. During this event, in each development device 11, an electrostatic latent image formed by a light emitting diode (LED) head 41 to be described later is developed on the surface of photosensitive drum 20 using development roller 35, also to be described later. Hence, toner images of black, yellow, magenta, and cyan are formed. These toner images of black, yellow, magenta, and cyan are transferred from the surfaces of photosensitive drums 20 to medium 13 by electrostatic forces of transfer rollers 23, so that a color toner image is formed.

Note that reference numeral 33 denotes a correction sensor unit that includes a color deviation detection sensor and a concentration detection sensor. Correction sensor unit 33 is configured to perform a color deviation correction and a concentration correction when image formation apparatus 10 is actuated.

Moreover, reference numeral 24 denotes a fixer configured such that a toner image transferred to medium 13 is fixed to medium 13 by heat and pressure. Fixer 24 includes heat roller 25, fixation belt 26, back-up roller 27, and halogen lamps 28a and 28b respectively disposed in heat roller 25 and back-up roller 27. Then, medium 13 to which the toner image is fixed bypassing through fixer 24, in other words, printed medium 13, is conveyed while being sandwiched between pinch rollers 31a, 31b and discharge rollers 30a, 30b as a medium discharge unit. Then, medium 13 is discharged onto stacker 32 formed at a top portion of the main body of image formation apparatus 10. Each of heat roller 25 and discharge rollers 30a, 30b is configured to rotate by a power transmitted from an unillustrated drive source via a gear and so forth.

Next, configurations of development device 11 and fixer 24 are described in detail.

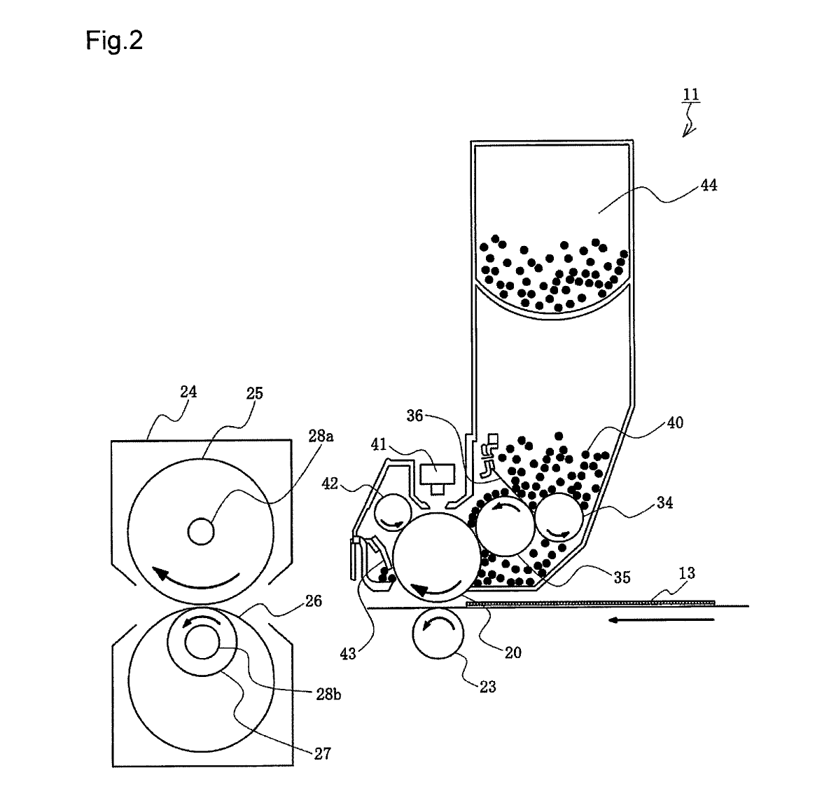

FIG. 2 is a schematic configuration diagram of the development device and the fixer according to the first embodiment of the invention.

In the figure, the right side illustrates the configuration of a portion of image formation apparatus 10 where electrophotographic development and transfer steps are performed, and the left side illustrates the configuration of a portion of image formation apparatus 10 where a fixation step is performed.

As illustrated, development device 11 includes: photosensitive drum 20 on the surface of which an electrostatic latent image is formed; electrical charge roller 42 configured to electrically charge the surface of photosensitive drum 20; LED head 41 as an exposure device configured to expose the surface of photosensitive drum 20 to light to thereby form an electrostatic latent image thereon; development roller 35 as a developer bearing member configured to supply toner 40 to the surface of photosensitive drum 20; sponge roller 34 as a developer supply member configured to supply toner 40 to development roller 35; development blade 36 as a toner layer formation member configured to form a thin layer of toner 40 on the surface of development roller 35; cleaner blade 43 configured to scrape off toner 40 remaining on the surface of photosensitive drum 20; and toner cartridge 44 configured to accommodate toner 40 as a developer therein and to supply toner 40 to sponge roller 34. Note that photosensitive drum 20 is in contact with electrical charge roller 42, development roller 35, and cleaner blade 43, while development roller 35 is in contact with sponge roller 34 and development blade 36.

Moreover, as illustrated, fixer 24 includes: heat roller 25 in the form of a circular pipe made of aluminium whose surface is coated with a tetrafluoroethylene-perfluoroalkyl vinyl ether copolymer (PFA) or polytetrafluoroethylene (PTFE); back-up roller 27 as an elastic roller, fixation belt 26 in the form of continuous track made of a resin such as polyimide; and halogen lamps 28a and 28b as heat sources respectively disposed inside heat roller 25 and back-up roller 27. Note that heat roller 25 is in pressure contact with back-up roller 27.

Although unillustrated, a gear configured to transmit a power is fixed by press fitting or other similar methods to each of the rollers and the drum of development device 11 and fixer 24 except for back-up roller 27. Here, the gear fixed to photosensitive drum 20 is referred to as a drum gear, the gear fixed to development roller 35 is referred to as a development gear, the gear fixed to sponge roller 34 is referred to as a sponge gear, the gear fixed to electrical charge roller 42 is referred to as a charge gear, the gears fixed to drive rollers 21a and 21b of the transfer unit are referred to as drive gears, the gear fixed to transfer roller 23 is referred to as a transfer gear, a gear installed between the development gear and the sponge gear is referred to as an idle gear, and the gear fixed to heat roller 25 is referred to as a heat roller gear.

Further, to each of the rollers and LED head 41 of development device 11 and halogen lamps 28a and 28b of fixer 24, a bias charge is applied from an unillustrated power source disposed in the main body of image formation apparatus 10. The power source is one used as a high-voltage power source for a usual electrophotographic printer, and is controlled by an unillustrated controller of image formation apparatus 10.

When the controller instructs a printing, a motor disposed as an (unillustrated) drive source in the main body of image formation apparatus 10 rotates to transmit power to the drum gear via unillustrated gears, thereby rotating photosensitive drum 20. Moreover, when the power is transmitted from the drum gear to the development gear, development roller 35 rotates. Further, the power is transmitted from the development gear to the sponge gear via the idle gear, and thereby sponge roller 34 rotates. On the other hand, when the power is transmitted from the drum gear to the charge gear, electrical charge roller 42 rotates. In addition, when the power is transmitted from the drum gear to the transfer gear, transfer roller 23 rotates. Further, the rotation of the motor is transmitted to the heat roller gear via gears in another line, and thereby heat roller 25 rotates. Moreover, fixation belt 26 and back-up roller 27 rotate in a manner accompanying the rotation of heat roller 25. Note that the arrows in the figure illustrate rotation directions of the rollers and the drum.

Meanwhile, almost simultaneously with the initiation of the motor rotation, a predetermined bias voltage is applied from the power source to each of the rollers and LED head 41 of development device 11 and halogen lamps 28a and 28b of fixer 24. Then, the surface of photosensitive drum 20 is electrically and uniformly charged by the voltage applied to electrical charge roller 42 and the rotation thereof. Subsequently, photosensitive drum 20 rotates, and the charged portion of the surface of photosensitive drum 20 reaches a position below LED head 41. At this time, LED head 41 emits light according to an image to be formed, the image having been inputted to the controller. Thus, an electrostatic latent image is formed on the surface of photosensitive drum 20. Thereafter, photosensitive drum 20 rotates, and the portion of the surface of photosensitive drum 20 where the electrostatic latent image is formed reaches development roller 35. At this time, a thin layer of toner 40 formed on development roller 35 by development blade 36 is transferred to the surface of photosensitive drum 20 due to a potential difference between development roller 35 and the electrostatic latent image formed on the surface of photosensitive drum 20. Thereby, the electrostatic latent image is developed, and the toner image is formed on the surface of photosensitive drum 20.

Subsequently, photosensitive drum 20 rotates, and the portion of the surface of photosensitive drum 20 where the toner image is formed reaches transfer roller 23. At this time, due to a potential difference between the surface of photosensitive drum 20 and transfer roller 23, the toner image is transferred from the surface of photosensitive drum 20 onto medium 13 conveyed by transfer belt 22. Note that cleaner blade 43 scrapes off a non-transferred portion of toner 40 remaining on photosensitive drum 20. After the completion of the image formation, the scraped toner is collected into an unillustrated waste toner box through an unillustrated waste toner tube.

Then, medium 13 on which the toner image is transferred is conveyed to fixer 24 located downstream of development devices 11 in the conveyance path, and passes between rotating heat roller 25 and fixation belt 26. In this event, the toner image on medium 13 is fixed to medium 13 by a pressure between heat roller 25 and fixation belt 26 and heat from heat roller 25 and back-up roller 27 heated by halogen lamps 28a and 28b.

Furthermore, when the power source of image formation apparatus 10 is turned on, toner 40 in a specific color deviation pattern and a concentration detection pattern is transferred onto transfer belt 22. Then, the color deviation detection sensor and the concentration detection sensor of correction sensor unit 33 read the color deviation pattern and the concentration detection pattern on transfer belt 22 to thereby perform a color deviation correction and a concentration correction.

Next, toner 40 is described in detail.

Toner 40 in this embodiment is produced by a dissolution suspension method known to a person skilled in the art to which it pertains (for example, disclosed in U.S. patent application publication US2007/0054210), except that a predetermined amount of a colorant and no pigment dispersant are dissolved in ethyl acetate.

Note that, U.S. patent application publication US2007/0054210 discloses a general dissolution suspension method using calcium phosphate (See Paragraphs 0230 to 0234 in US2007/0054210) and Examples thereof use a sodium salt of dodecyldiphenyletherdisulfonic acid in preparation of water phase (see Paragraph 0248 in US2007/0054210), while the following Examples 1-1 to 1-8 and Example 2 in this application use water phase (suspension stabilizer solution) containing calcium phosphate.

Note that, Examples 1 to 3 disclosed in US2007/0054210 prepare and use master batches (1) to (3) (see paragraphs 0262 to 0264, 0285 to 0287, and 0288 to 0290 in US2007/0054210); however, the following Examples 1-1 to 1-8 and Example 2 in this application do not use a master batch.

In this embodiment, as a binder resin to obtain toner 40, it is possible to use thermoplastic resins such as vinyl resins, polyamide resins, polyester resins, and polyurethane resins.

It is possible to use any of the following as a solvent used as an organic solvent to dissolve the binder resin in a dissolution suspension method: ethyl acetate; hydrocarbon-based solvents such as xylene and hexane; ester-based solvents such as methyl acetate, ethyl acetate, butyl acetate, and isopropyl acetate; ether-based solvents such as diethyl ether; and ketone-based solvents such as acetone, methyl ethyl ketone, diisobutyl ketone, cyclohexanone, and methylcyclohexane.

Moreover, as a release agent, it is possible to use higher fatty acids and metal salts thereof, fatty acid amides, ester waxes, aliphatic hydrocarbon-based waxes including paraffin-polyolefin-based waxes and modified products thereof, and the like. In consideration of the easiness of preparing a wax dispersion by the dissolution suspension method and the easiness of its incorporation into toner 40, it is preferable to use aliphatic hydrocarbon-based waxes and ester waxes.

Further, as an inorganic powder, it is possible to use: oxides of metals such as zinc, aluminium, cerium, cobalt, iron, zirconium, chromium, manganese, strontium, tin, and antimony; compound metal oxides such as calcium titanate, magnesium titanate, and strontium titanate; metal salts such as barium sulfate, calcium carbonate, magnesium carbonate, and aluminium carbonate; clay minerals such as kaolin; phosphoric acid compounds such as apatite; silicon compounds such as silica, silicon carbide, and silicon nitride; and carbon powders such as carbon black, and graphite.

Furthermore, a suspension stabilizer used in the dissolution suspension method is preferably one that can be removed using an acid having no affinity for the solvent because toner particles are granulated with the suspension stabilizer and adhere to the particle surface after the dispersion. For example, it is possible to use calcium carbonate, calcium chloride, sodium hydrogen carbonate, potassium hydrogen carbonate, hydroxyapatite, calcium phosphate, and the like.

Next, Examples and evaluation results of toners 40 produced by a toner production method according to this embodiment are described.

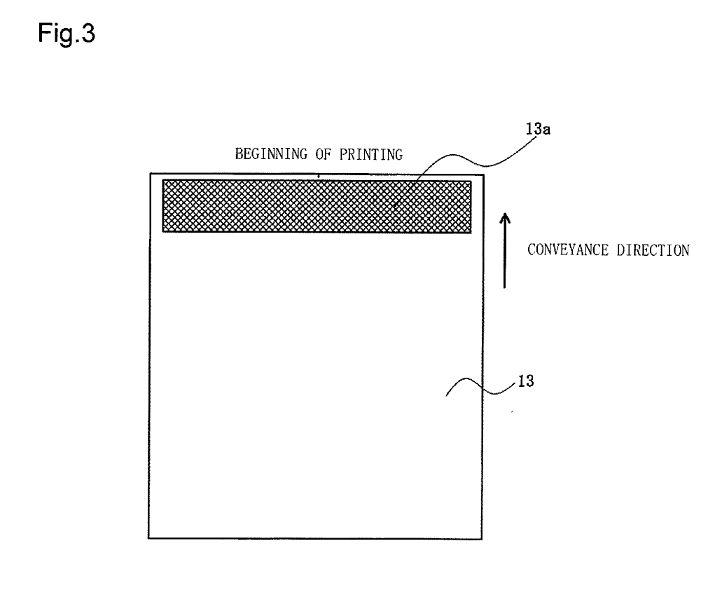

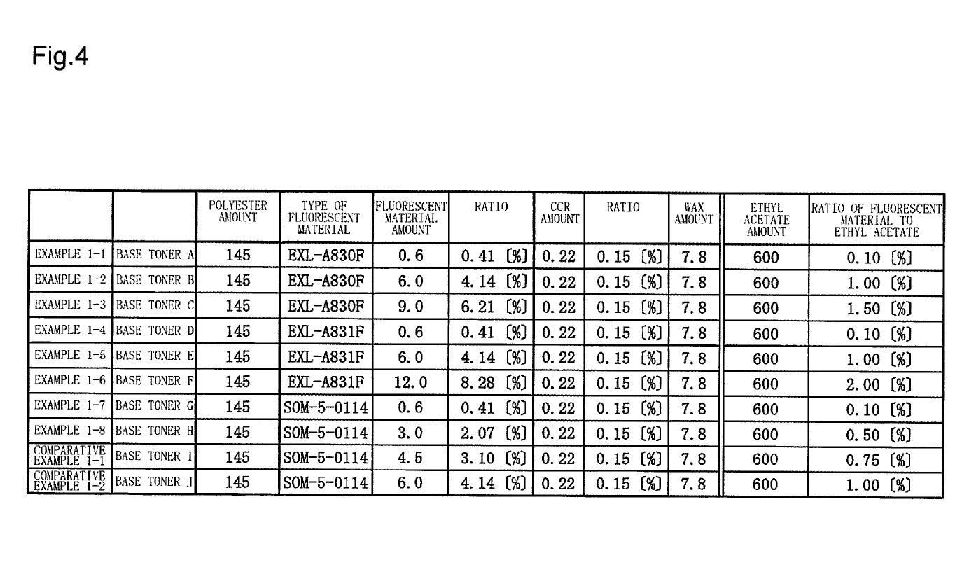

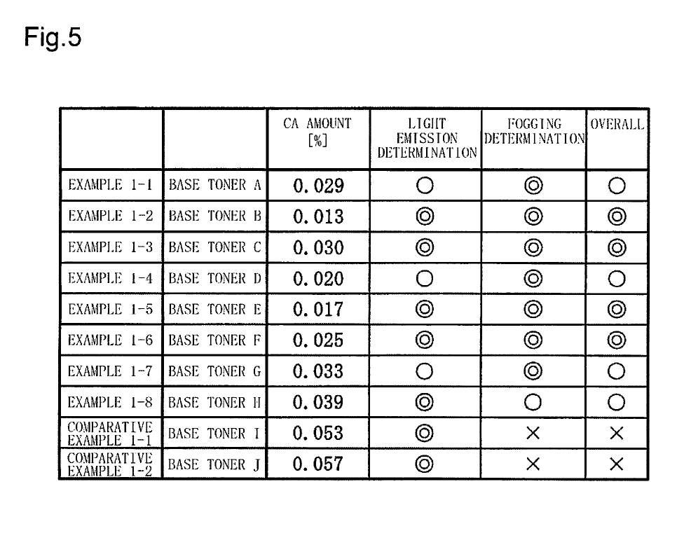

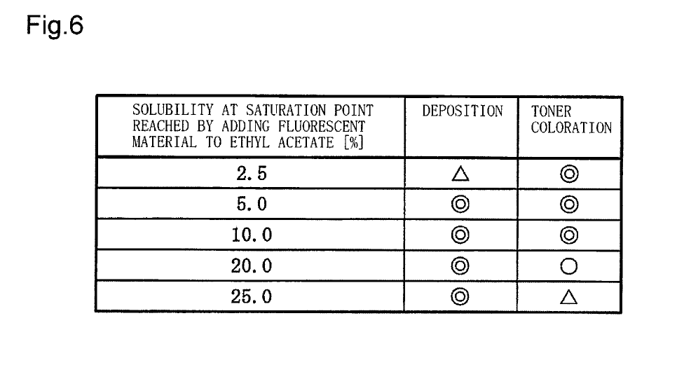

FIG. 3 is a drawing for explaining a method of evaluating the Examples according to the first embodiment of the invention. FIG. 4 is a table for illustrating compositions of dispersed phases of the Examples according to the first embodiment of the invention. FIG. 5 is a table for illustrating Ca element amounts and the evaluation results of the Examples according to the first embodiment of the invention. FIG. 6 is a table for illustrating how the solubilities of fluorescent materials (colorant) of the Examples according to the first embodiment of the invention correlate with deposition and toner coloration.

The inventor of the invention, as described below, produced toners 40 of Examples 1-1 to 1-8 and toners 40 of Comparative Examples 1-1 and 1-2, and evaluated Examples 1-1 to 1-8 and Comparative Examples 1-1 and 1-2.

First, Example 1-1 is described.

The binder resin material used is OCR-7 (manufactured by Kao Corporation) that is a polyester resin having an acid value of 2.9 [mgKOH/g], a weight being the average molecular weight (in terms of styrene) of approximately 220,000. Further, the release agent used is WEP-4 (manufactured by NOF CORPORATION) that is an ester wax. The fluorescent material, serving as colorant, used is EXL-A830F (manufactured by Sinloihi Co., Ltd., solubility in ethyl acetate: 10[%] or more, the color when light is emitted: blue). The charge control resin (CCR) used is an acrylic base FCA-726 (manufactured by Fujikura Kasei Co., Ltd.). The solvent used is ethyl acetate.

The physical properties of the release agent WEP-4 are: a melting point of 71[° C.], a viscosity (at 90[° C.]) of 10 [mPa·s], and a weight as the average molecular weight (in terms of styrene) of approximately 1650. Then, the weight being the average molecular weight of the release agent is measured using a Shimadzu GPC System (manufactured by Shimadzu Corporation) with two columns of “TSKgel GMHXL (inner diameter: 7.8 [mm], length: 30 [cm])” (manufactured by Tosoh Corporation) and one column of “TSKgel G2500HXL (inner diameter: 7.8 [mm], length [cm])” (manufactured by Tosoh Corporation), and tetrahydrofuran (THF) as an eluent. Note that the measurement conditions are: a sample concentration of 1[%], a flow rate of 1.0 [ml/min.], a column temperature of 40[° C.], and a sample injection amount of 200 [μl]. An IR detector is used.

Moreover, the selected fluorescent material is soluble in the solvent of ethyl acetate. This is because a pigment dispersant used for normal four-color pigments often causes color development by itself and cannot be used, and because if a fluorescent material contains a component insoluble in ethyl acetate, when a toner produced therewith is used for printing, the transparency cannot be ensured, which creates potential problems in the color development. Meanwhile, in a normal four-color toner, a fluorescent material is added in an amount of approximately 5 to 10[%] relative to a binder resin. Suppose (when a composition has a ratio of ethyl acetate-to-binder resin of 100:25) that the amount of a fluorescent material dissolved is 2.5[%] or more relative to ethyl acetate. In this case, it is possible to add the fluorescent material in an amount of 10[%] or more relative to the binder resin. However, if the solubility in ethyl acetate is to be at the limit, the fluorescent material may be deposited at the step of removing ethyl acetate in the dissolution suspension method. Hence, it is expectedly difficult to ensure the dispersion of the fluorescent material and the transparency at the time of printing. From these, considering an extra solubility, it is desirable to select a fluorescent material that is dissolved in an amount of 5.0[%] or more relative to the ethyl acetate.

Herein, the phrase dissolved in an amount of 5.0[%] relative to ethyl acetate means a ratio of a fluorescent material to ethyl acetate; strictly, the amount of the fluorescent material is 0.5 [g] and is at the saturation point reached by continuously adding the fluorescent material to 10 [g] of ethyl acetate at 60[° C.] in an temperature-humidity environment where the temperature is 23[° C.] and the humidity is 50[%] (here, the ratio is (0.5/10)×100[%]).

Note that if a fluorescent material is excessively dissolved in ethyl acetate, the transparency of a produced toner is lowered, so that the produced toner is colored presumably. Hence, it is desirable to select a fluorescent material dissolved in an amount of 20[%] or less relative to ethyl acetate. Specifically, it is desirable to select a fluorescent material dissolved in an amount of 5.0 to 20[%] relative to ethyl acetate. Furthermore, in consideration of the environmental dependency during the toner production, it is more desirable to select a fluorescent material dissolved in an amount of 5.0 to 10[%] relative to ethyl acetate.

The inventor of the invention selected fluorescent materials different in solubility at the saturation point reached by adding the fluorescent materials to ethyl acetate. Then, the inventor evaluated the fluorescent materials regarding deposition and toner coloration. FIG. 6 illustrates the evaluation results. Note that, in the column of deposition in FIG. 6, “Δ” indicates that the deposition may occur, and (A) indicates that the deposition does not occur. Moreover, in the column of toner coloration, “Δ” indicates that toner coloration may occur; “∘” indicates that even if toner coloration occurs, this does not cause a problem visually; and “⊚” indicates that toner coloration does not occur.

As illustrated in FIG. 6, the fluorescent material dissolved in an amount of 2.5[%] relative to ethyl acetate is deposited in some cases, depending on the toner purification environment. Moreover, as for the fluorescent material dissolved in an amount of 20.0[%] relative to ethyl acetate, the level of toner coloration, if coloration occurs, does not cause a problem visually. Furthermore, as for the fluorescent material dissolved in an amount of 25.0[%] relative to ethyl acetate, toner coloration occurs in some cases, depending on the toner purification environment. These evaluation results support the above explanation.

A mixture solution of these (hereinafter referred to as dispersed phase) has a composition of: 145 parts by weight of OCR-7, 7.8 parts by weight of WEP-4, 0.6 parts by weight of EXL-A830F, 0.22 parts by weight of FCA-726, and 600 parts by weight of ethyl acetate.

Incidentally, other materials such as, for example, a charge control agent and an inorganic powder may be added, as necessary, in such amounts that the toner particles are not colored.

Then, the dispersed phase is heated to 50[° C.] and stirred until solid matter disappears. FIG. 4 illustrates the final composition of the dispersed phase ([ratio] in FIG. 4 is a ratio of the amount of the fluorescent material to the amount of polyester).

On the other hand, a continuous phase has a composition of: 3,000 parts by weight of water and 102 parts by weight of trisodium phosphate dodecahydrate.

Then, after the continuous phase is stirred and dissolved by heating to 60[ ° C.], dilute nitric acid for pH adjustment is added thereto. Subsequently, an aqueous solution of calcium chloride obtained by dissolving 49.2 parts by weight of anhydrous calcium chloride in 500 parts by weight of pure water, followed by heating to 60[° C.] is added, and rapidly stirred using a Neo Mixer (manufactured by PRIMIX Corporation) at a revolution speed of 10,000 [rpm] for 5 minutes. Thereby, an aqueous medium containing calcium phosphate (suspension stabilizer solution) is obtained. After that, the dispersed phase is introduced into the continuous phase, and further the mixture is rapidly stirred using Neo Mixer at a revolution speed of 8,000 [rpm] for 30 seconds for granulation.

Thereafter, ethyl acetate is removed by distillation under a reduced pressure. Then, the slurry is cooled, and acid cleaning and dehydration are performed to remove the suspension stabilizer. After water washing, the resultant is dehydrated and dried to thus obtain base toner A.

Note that during the acid cleaning and the water washing, no separation and elution of the fluorescent material are observed.

Then, 1.0 parts by weight of hydrophobic silica R-8200 (manufactured by Nippon Aerosil Co., Ltd., average primary particle diameter: 12 [nm]) is added to 100 parts by weight of base toner A, and mixed using a Henschel mixer (manufactured by Mitsui Mining Co., Ltd.). Thus, an external additive toner is prepared.

Subsequently, elemental analysis is conducted on Example 1-1. Specifically, the calcium element amount in particles of base toner A obtained as described above is measured in a He atmosphere using an energy dispersive X-ray fluorescence spectrometer EDX-800HS2 (manufactured by Shimadzu Corporation). The X-ray voltage is 15 [kV]. Moreover, the element content is determined by a method in which a total of elements detected from the measured intensities is calculated as 100[%].

As a result of conducting the elemental analysis in this manner, the calcium element content of base toner A is 0.029[%] as illustrated in FIG. 5.

Subsequently, the printing of Example 1-1 is evaluated. Specifically, the toner particles obtained as described above are placed as toner 40 in development device 11, and printing is performed on medium 13 using image formation apparatus 10 to evaluate the print quality.

As medium 13, a print sheet containing no fluorescent pigment, for example, an OKI excellent gloss sheet (A4 size, 128 [g/m]) is used, and 24 sheets are conveyed per minute in an A4-vertical transport mode. As illustrated in FIG. 3, solid printing is performed on a predetermined area. Specifically, the solid printing is performed on print portion 13a illustrated in FIG. 3 in a 14[%]-area of the 100[%] complete solid printing area (the amount of the toner adhering to the sheet surface: 0.40 [mg/cm]). Print portion 13a is located at a portion near a tip end in the conveyance direction of medium 13, that is, a portion where printing begins, and has an area corresponding to 14[%] of the entire printing area of medium 13.

Then, solid-printed print portion 13a is irradiated with ultraviolet light to determine the degree of light emission, in other words, light emission determination is performed. The result of the light emission determination is indicated by “⊚”, “∘”, or “x” as illustrated in FIG. 5. Here, “⊚” means that light emission is easily visually observed, “∘” means that light emission is dull but visually observed, and “x” means that light emission is not visually observed.

In addition, a fogging determination is performed on a portion other than print portion 13a, that is, on a blank portion of medium 13. The result of the fogging determination is indicated by “⊚”, “∘”, or “x” as illustrated in FIG. 5. Here, “⊚” means that no fogging occurs at all, “∘” means that fogging occurs a little but is hardly noticeable, and “x” means that fogging is visually observed.

Note that, in the light emission determination and in the fogging determination, “∘” means acceptable.

As illustrated in FIG. 5, the printing of Example 1-1 is evaluated as “∘” in the light emission determination, “⊚” in the fogging determination, and overall “∘”. In other words, the printing is performed without any problem.

Next, Example 1-2 is described. While the amount of the fluorescent material EXL-A830F is 0.6 parts by weight in Example 1-1, the amount of EXL-A830F is changed to 6.0 parts by weight in Example 1-2 to thus obtain base toner B. Note that the other components are the same as those in Example 1-1.

Subsequently, an elemental analysis is conducted on Example 1-2. As a result of conducting the elemental analysis as in Example 1-1, the calcium element content of base toner B is 0.013[%] as illustrated in FIG. 5.

Subsequently, the printing of Example 1-2 is evaluated. As a result of evaluating the printing as in Example 1-1, the printing of Example 1-2 is evaluated as illustrated in FIG. 5: “⊚” in the light emission determination, “⊚” in the fogging determination, and overall “⊚”. In other words, a favorable printing is performed.

Next, Example 1-3 is described. While the amount of the fluorescent material EXL-A830F is 0.6 parts by weight in Example 1-1, the amount of EXL-A830F is changed to 9.0 parts by weight in Example 1-3 to thus obtain base toner C. Note that the other components are the same as those in Example 1-1.

Subsequently, an elemental analysis is conducted on Example 1-3. As a result of conducting the elemental analysis as in Example 1-1, the calcium element content of base toner C is 0.030[%] as illustrated in FIG. 5.

Subsequently, the printing of Example 1-3 is evaluated. As a result of evaluating the printing as in Example 1-1, the printing of Example 1-3 is evaluated as illustrated in FIG. 5: “⊚” in the light emission determination, “⊚” in the fogging determination, and overall “⊚”. In other words, favorable printing is performed.

Next, Example 1-4 is described. While EXL-A830F is used as the fluorescent material in Example 1-1, the fluorescent material is changed to EXL-A831F (manufactured by Sinloihi Co., Ltd., solubility in ethyl acetate: 10[%] or more, the color when light is emitted: green) in Example 1-4 to thus obtain base toner D. Note that the other components are the same as those in Example 1-1.

Subsequently, an elemental analysis is conducted on Example 1-4. As a result of conducting the elemental analysis as in Example 1-1, the calcium element content of base toner D is 0.020[%] as illustrated in FIG. 5.

Subsequently, the printing of Example 1-4 is evaluated. As a result of evaluating the printing as in Example 1-1, the printing of Example 1-4 is evaluated as illustrated in FIG. 5: “∘” in the light emission determination, “⊚” in the fogging determination, and overall “∘”. In other words, the printing is performed without any problem.

Next, Example 1-5 is described. While the amount of fluorescent material EXL-A831F is 0.6 parts by weight in Example 1-4, the amount of EXL-A831F is changed to 6.0 parts by weight in Example 1-5 to thus obtain base toner E. Note that the other components are the same as those in Example 1-4.

Subsequently, an elemental analysis is conducted on Example 1-5. As a result of conducting the elemental analysis as in Example 1-1, the calcium element content of base toner E is 0.017[%] as illustrated in FIG. 5.

Subsequently, the printing of Example 1-5 is evaluated. As a result of evaluating the printing as in Example 1-1, the printing of Example 1-5 is evaluated as illustrated in FIG. 5: “⊚” in the light emission determination, “⊚” in the fogging determination, and overall “⊚”. In other words, favorable printing is performed.

Next, Example 1-6 is described. While the amount of the fluorescent material EXL-A831F is 0.6 parts by weight in Example 1-4, the amount of EXL-A831F is changed to 12.0 parts by weight in Example 1-6 to thus obtain base toner F. Note that the other components are the same as those in Example 1-4.

Subsequently, an elemental analysis is conducted on Example 1-6. As a result of conducting the elemental analysis as in Example 1-1, the calcium element content of base toner F is 0.025[%] as illustrated in FIG. 5.

Subsequently, the printing of Example 1-6 is evaluated. As a result of evaluating the printing as in Example 1-1, the printing of Example 1-6 is evaluated as illustrated in FIG. 5: “⊚” in the light emission determination, “⊚” in the fogging determination, and overall “⊚”. In other words, favorable printing is performed.

Next, Example 1-7 is described. While EXL-A830F is used as the fluorescent material in Example 1-1, the fluorescent material is changed to SOM-5-0114 (manufactured by Orient Chemical Industries Co., Ltd., solubility in ethyl acetate: 10[%] or more, the color when light is emitted: red) in Example 1-7 to thus obtain base toner G. Note that the other components are the same as those in Example 1-1.

Subsequently, an elemental analysis is conducted on Example 1-7. As a result of conducting the elemental analysis as in Example 1-1, the calcium element content of base toner G is 0.033[%] as illustrated in FIG. 5.

Subsequently, the printing of Example 1-7 is evaluated. As a result of evaluating the printing as in Example 1-1, the printing of Example 1-7 is evaluated as illustrated in FIG. 5: “∘” in the light emission determination, “⊚” in the fogging determination, and overall “∘”. In other words, the printing is performed without any problem.

Next, Example 1-8 is described. While the amount of the fluorescent material SOM-5-0114 is 0.6 parts by weight in Example 1-7, the amount of SOM-5-0114 is changed to 3.0 parts by weight in Example 1-8 to thus obtain base toner H. Note that the other components are the same as those in Example 1-7.

Subsequently, an elemental analysis is conducted on Example 1-8. As a result of conducting the elemental analysis as in Example 1-1, the calcium element content of base toner H is 0.039[%] as illustrated in FIG. 5.

Subsequently, the printing of Example 1-8 is evaluated. As a result of evaluating the printing as in Example 1-1, the printing of Example 1-8 is evaluated as illustrated in FIG. 5: “⊚” in the light emission determination, “∘” in the fogging determination, and overall “∘”. In other words, the printing is performed without any problem.

Next, Comparative Example 1-1 is described. While the amount of the fluorescent material SOM-5-0114 is 0.6 parts by weight in Example 1-7, the amount of SOM-5-0114 is changed to 4.5 parts by weight in Comparative Example 1-1 to thus obtain base toner I. Note that the other components are the same as those in Example 1-7.

Subsequently, an elemental analysis is conducted on Comparative Example 1-1. As a result of conducting the elemental analysis as in Example 1-1, the calcium element content of base toner I is 0.053[%] as illustrated in FIG. 5.

Subsequently, the printing of Comparative Example 1-1 is evaluated. As a result of evaluating the printing as in Example 1-1, the printing of Comparative Example 1-1 is evaluated as illustrated in FIG. 5: “⊚” in the light emission determination, “x” in the fogging determination, and overall “x”. In other words, the printing is performed with unfavorable fogging.

Next, Comparative Example 1-2 is described. While the amount of the fluorescent material SOM-5-0114 is 0.6 parts by weight in Example 1-7, the amount of SOM-5-0114 is changed to 6.0 parts by weight in Comparative Example 1-2 to thus obtain base toner J. Note that the other components are the same as those in Example 1-7.

Subsequently, an elemental analysis is conducted on Comparative Example 1-2. As a result of conducting the elemental analysis as in Example 1-1, the calcium element content of base toner J is 0.057[%] as illustrated in FIG. 5.

Subsequently, the printing of Comparative Example 1-2 is evaluated. As a result of evaluating the printing as in Example 1-1, the printing of Comparative Example 1-2 is evaluated as illustrated in FIG. 5: “⊚” in the light emission determination, “x” in the fogging determination, and overall “x”. In other words, the printing is performed with unfavorable fogging.

It can be seen from the results illustrated in FIGS. 4 and 5 that if the calcium element content of toner 40 exceeds 0.050[%], the suspension stabilizer incorporated in toner 40 inhibits the electrically charged state of toner 40, so that fogging occurs.

Specifically, it can be seen from the printing evaluation result that if the calcium element content is 0.050[%] or less, the result of the light emission determination is favorable, and the result of the fogging determination is acceptable. Accordingly, it can be concluded that the calcium element content in toner 40 is desirably 0.050[%] or less. Further, it can be concluded that the calcium element content in toner 40 is more desirably 0.039[%] or less.

Meanwhile, although it is desirable to select a fluorescent material dissolved in an amount of 5.0[%] or more relative to ethyl acetate, if the amount of the fluorescent material exceeds 2.0[%] relative to ethyl acetate, the fluorescent material is deposited during the step of removing ethyl acetate, the step being performed after the fluorescent material is actually dissolved. This makes it difficult to ensure the transparency at the time of printing in some cases. For this reason, the amount of the fluorescent material is desirably 2.0[%] or less relative to ethyl acetate, that is, 8.28[%] or less relative to polyester. In contrast, if the amount of the fluorescent material is below 0.10[%], this makes it difficult to visually observe the light emission. For this reason, the amount of the fluorescent material is desirably 0.10[%] or more relative to ethyl acetate, that is, 0.41[%] or more relative to polyester.

In Examples 1-1 to 1-3, in a range where the amount of the fluorescent material is 4.14 to 6.21[%] relative to polyester, no large difference is observed in light emission intensity at the time of printing. From this, it is determined that no increase in light emission intensity is expected by further increasing the amount of the fluorescent material. Hence, no additional experiment is conducted.

In Examples 1-4 to 1-6, in a range where the amount of the fluorescent material is 4.14 to 8.28[%] relative to polyester, a difference is observed in light emission intensity at the time of printing. However, it is expected that the fluorescent material is deposited by further increasing the amount of the fluorescent material. Hence, no additional experiment is conducted.

In Examples 1-7, 1-8 and Comparative Examples 1-1, 1-2, there is a tendency that the larger the amount of the fluorescent material, the higher the calcium element content. This is presumably because the fluorescent material SOM-5-0114 contains a europium complex, and the europium complex is likely to attract the suspension stabilizer. Thus, when a fluorescent material containing a europium complex is to be used, it is desirable to add such a fluorescent material carefully so as not to incorporate the suspension stabilizer too much.

As described above, in this embodiment, toner 40 is produced by a dissolution suspension method using a dispersed phase containing at least a release agent. Further, a fluorescent material dissolved in an amount of 5.0[%] or more relative to ethyl acetate is used. Without using a pigment dispersant, the fluorescent material is used in an amount of 0.10 to 2.00[%] relative to ethyl acetate, that is, 0.41 to 8.28[%] relative to polyester. This makes it possible to produce toner 40 having a calcium element amount of 0.050[%] or less. Toner 40 thus obtained is transparent upon exposure to visible light, is capable of emitting light upon exposure to ultraviolet light, and causes no fogging problem.

Note that, in order to make the light emission intensity favorable and further reduce fogging, the ratio of the fluorescent material to polyester is desirably 4.14 to 6.21[%] in a case where EXL-A830F is used as the fluorescent material; meanwhile, in a case where EXL-A831F is used as the fluorescent material, the ratio of the fluorescent material to polyester is desirably 4.14 to 8.28[%].

Next, a second embodiment of the invention is described. Note that components having the same configurations as those in the first embodiment are denoted by the same reference symbols. Accordingly, a description thereof is omitted. Moreover, a description of the same operations and effects as those in the first embodiment is also omitted.

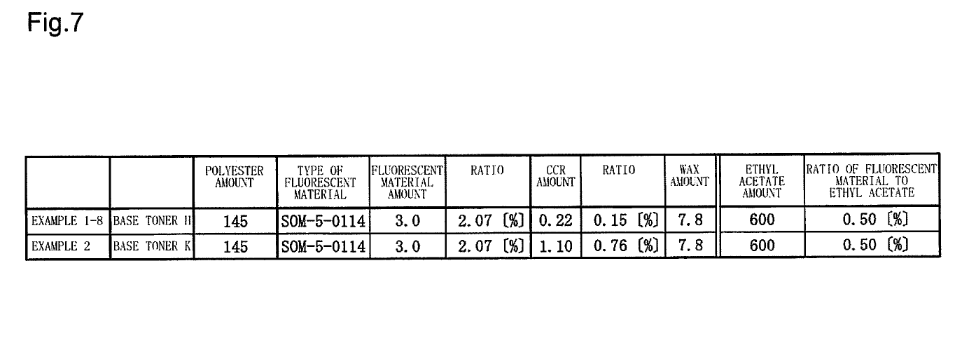

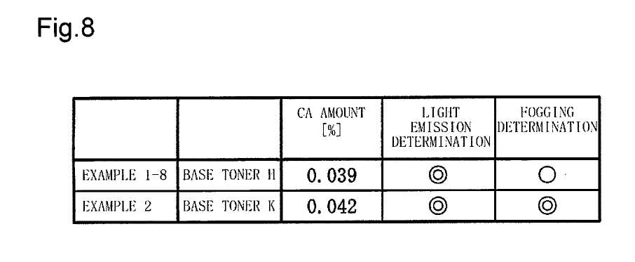

FIG. 7 is a table for illustrating a composition of a dispersed phase of an Example according to the second embodiment of the invention. FIG. 8 is a table for illustrating a Ca element amount and the evaluation result of the Example according to the second embodiment of the invention.

In this embodiment, the inventor of the invention, as described below, produced toner 40 of Example 2, and evaluated Example 2 in comparison with Example 1-8 described in the first embodiment.

In Example 2, SOM-5-0114 containing a europium complex is used as the fluorescent material, as in Example 1-8. Moreover, the amount of the charge control resin (CCR) is changed to further suppress fogging while ensuring the degree of light emission. A larger amount of a CCR tends to enhance the charge characteristic of toner 40 and reduce fogging. However, during the production, there is a risk of incorporating a suspension stabilizer as the viscosity of a dispersed phase is increased. Hence, toner 40 has to be produced by paying attention to the calcium element amount detected by an elemental analysis when the amount of a CCR is to be increased.

Specifically, while the amount of CCR is 0.22 parts by weight in Example 1-8, the amount of CCR is changed to 1.10 parts by weight in Example 2 to thus obtain base toner K. Note that the other components are the same as those in Example 1-8.

Subsequently, an elemental analysis is conducted on Example 2. As a result of conducting the elemental analysis as in Example 1-1, the calcium element content of base toner K is 0.042[%] as illustrated in FIG. 8.

Subsequently, the printing of Example 2 was evaluated. As a result of evaluating the printing, similar to the printing evaluation as in Example 1-1, the printing of Example 2 is evaluated as illustrated in FIG. 8: “⊚” in the light emission determination, and “⊚” in the fogging determination. In other words, favorable printing is performed.

It can be seen from the results illustrated in FIGS. 7 and 8 that, while the amount of the fluorescent material SOM-5-0114 is set the same, the amount of the CCR is increased in Example 2 in comparison with Example 1-8, but the calcium element content is hardly changed. In addition, the CCR effect presumably enhances the charge characteristic of toner 40 and reduces fogging.

As described above, in this embodiment, SOM-5-0114 is used as the fluorescent material dissolved in an amount of 5.0[%] or more relative to ethyl acetate. Without using a pigment dispersant, the fluorescent material is used in an amount of 0.10 to 0.75[%] relative to ethyl acetate, that is, 0.41 to 2.07[%] relative to polyester. Moreover, the CCR is used in an amount of 0.15 to 0.76[%] relative to polyester. This makes it possible to produce toner 40 having a calcium element amount of 0.050[%] or less. Toner 40 thus obtained is transparent upon exposure to visible light, is capable of emitting light upon exposure to ultraviolet light, and causes no fogging problem.

It can be seen that the use of the fluorescent material in an amount of 2.07[%] relative to polyester and the use of the CCR in an amount of 0.76[%] relative to polyester particularly make the light emission intensity favorable and further reduce fogging.

The first and second embodiments are described with the image formation apparatus 10 as a printer. Nevertheless, the invention is applicable also to an MFP, a facsimile, and a copier.

Moreover, the invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. A toner production method of producing a toner by a dissolution suspension method, wherein
a colorant that is capable of being dissolved in a predetermined amount into ethyl acetate is used, and no pigment dispersant is used.

2. The toner production method according to claim 1, wherein
the colorant is a fluorescent material.

3. The toner production method according to claim 1, wherein the predetermined amount is 5.0 to 20[%] relative to the ethyl acetate.

4. The toner production method according to claim 1, wherein a calcium element content of the produced toner is 0.050[%] or less.

5. The toner production method according to claim 2, wherein the fluorescent material emits a blue light.

6. The toner production method according to claim 5, wherein an amount of the fluorescent material is 0.41 to 6.21[%] relative to a binder resin.

7. The toner production method according to claim 2, wherein the fluorescent material emits a green light.

8. The toner production method according to claim 7, wherein an amount of the fluorescent material is 0.41 to 8.28[%] relative to a binder resin.

9. The toner production method according to claim 2, wherein the fluorescent material comprises a europium complex and emits a red light.

10. The toner production method according to claim 9, wherein an amount of the fluorescent material is 0.41 to 2.07[%] relative to a binder resin.

11. The toner production method according to claim 10, wherein a charge control resin is used in an amount of 0.15 to 0.76[%] relative to the binder resin.

12. A toner produced by the toner production method according to claim 1.

13. A toner comprising
a colorant that is capable of being dissolved in a predetermined amount into ethyl acetate, wherein no pigment dispersant is used.

14. A toner cartridge containing therein the toner according to claim 12.

15. A development device comprising the toner according to claim 12.

16. An image formation apparatus comprising the development device according to claim 15.

17. A toner cartridge containing therein the toner according to claim 13.

18. A development device comprising the toner according to claim 13.

19. An image formation apparatus comprising the development device according to claim 18.

20. A method of producing a toner, comprising:
dissolving, during a dissolution suspension process, a colorant that is capable of being dissolved in a predetermined amount into ethyl acetate,
wherein no pigment dispersant is used in the dissolving of the colorant into ethyl acetate.

21. The method according to claim 20, wherein
the colorant comprises a fluorescent material.
